(19) United States
(12) Patent Application Publication
(10) Pub. No.: US 2020/0407567 A1
(43) Pub. Date: Dec. 31, 2020

(54) FINISH COAT COMPOSITION FOR CORROSION-RESISTANT COATING OF A METAL PART, WET-ON-WET METHOD FOR APPLYING A FINISH COAT, CORROSION-RESISTANT COATING OF METAL PARTS, AND COATED METAL PART

(71) Applicant: NOF METAL COATINGS EUROPE, CREIL (FR)

(72) Inventors: Olivier VALEYRE, Boran sur Oise (FR); Jean-François MENET, Lieuvillers (FR); Yan LAHAYE, La Neuville en Hez (FR)

(21) Appl. No.: 16/975,776

(22) PCT Filed: Feb. 26, 2019
(86) PCT No.: PCT/EP2019/054768

§ 371 Date: Aug. 26, 2020

(30) Foreign Application Priority Data
Feb. 26, 2018 (FR) 1851660

(51) Int. Cl. C09D 5/10; C09D 183/04; C09D 7/40; C09D 7/61

(52) U.S. Cl. CPC C09D 5/10; C09D 183/04; C08K 7/28; C09D 7/61; C09D 7/70

(57) ABSTRACT

The present invention relates to a finishing composition for coating a metal part previously coated with a corrosion-resistant coating comprising at least a binder of alkylphenylsiloxane type, glass microbeads, and optionally filler particles with a high thermal resistance and/or particulate aluminum, said composition having a thixotropic index (ITh) greater than or equal to 3. The present invention also relates to a corrosion-resistant coating of a metal part, resistant to acids and bases, contributing to the good thermal resistance of the system and comprising at least two coats different from each other, the first coat being a base coat comprising at least water, a particulate metal and a binder, and the second coat being a finishing composition according to the invention. The present invention further relates to the wet-on-wet-type method for applying the corrosion-resistant coating according to the invention and to a metal substrate coated with a corrosion-resistant coating according to the invention.

### INTRODUCTION

The present invention relates to a finishing composition for coating a metal part. The present invention also relates to a coating of a metal part comprising said finishing composition, the method for applying said coating as well as the metal substrate coated with said coating.

### PRIOR ART

Corrosion-resistant coating compositions now exist which allow to obtain corrosion-resistant coatings having a satisfactory cathodic protection even though the coating does not comprise hexavalent chromium. For example, patent EP 808 883 and international application WO 2005/078026 describe corrosion-resistant coating compositions free from hexavalent chromium and in which the main solvent is water.

However, these compositions remain vulnerable against the strong acids and weak bases present in most cleaners for metal parts, in particular for automobile parts. Indeed, traditional finishes do not allow the desired high chemical and thermal resistance performance to be achieved. Thus, it was considered to apply an additional coat of particular binder to provide a barrier effect protecting the surface against chemical aggression. However, this technology requires a second treatment on the metal parts, involving cooling and additional baking (see FIG. 1C). Due to the high baking temperature required to bake the initial coating (around 340° C. by induction), this leads to high energy consumption and requires significant improvements in terms of space for cooling the coated parts.

### DESCRIPTION OF THE INVENTION

The first object of the present invention is a finishing composition for coating a metal part previously coated with a corrosion-resistant coating comprising at least a binder of alkylphenylsiloxane type, glass microbeads, and optionally particles with a high thermal resistance and/or preferably lamellar aluminum, said composition having a thixotropic index (ITh) greater than or equal to 3.

Surprisingly, it has been observed that such a finishing composition confers to the coating, in particular to the corrosion-resistant coating, satisfactory protection against chemical aggression, in particular against strong acids and weak bases, and thermal aggression. Furthermore, such a composition can be applied according to a wet-on-wet type method, that is to say it can be directly applied to the metal substrate already coated with a first corrosion-resistant coating composition (hereinafter called base coat) that is still wet (cf. FIG. 1A). This allows to obtain a coating for a metal part having cathodic protection and protection against chemical and thermal aggression, using a method comprising only one baking and does not require additional cooling time. The present invention therefore allows a significant reduction in energy consumption compared to a two-coat two-bake treatment method (cf. FIG. 1D).

### Definition

Within the meaning of the present invention, “coating composition” means a composition in aqueous dispersion, intended to be applied to a substrate, in particular metal substrate, then subjected to a baking operation in order to produce the coating. “Aqueous medium” of the coating composition means water or a combination of water and an organic liquid. Other liquids can optionally be used with water or with the combination of water and organic liquid but, preferably, only a very minor amount of the medium is such other liquid material. Preferably, the aqueous medium is composed of water. Advantageously, the water is present in the coating composition in an amount of approximately 30 to 70%, in particular 30 to 60% by mass, relative to the total mass of the composition.

Within the meaning of the present invention, “base coat composition” or “base coat” means a coating composition as defined above, intended to be applied to a substrate, in particular metal substrate, said substrate not having been previously coated with another coating composition.

Within the meaning of the present invention, “finishing composition” or “finishing coat” means a coating composition as defined above, intended to be applied to a substrate, in particular metal substrate, said substrate having been previously coated with another coating composition, in particular with a base coat.

Within the meaning of the present invention, the “coating” is therefore obtained by applying one or more coating composition(s), for example a base coat composition and a finishing composition, on a substrate, in particular metal substrate, the coating coat(s) then being subjected to a baking operation. The terms “coating” and “corrosion-resistant coating” are used synonymously in the present application.

Within the meaning of the present invention, “wet coating coat” or “wet coating composition” means a coating composition as defined above which has not yet been subjected to a baking or crosslinking operation. Said coating composition is therefore still in a form which is not fully crosslinked. After baking or crosslinking, this is referred to as a dry or crosslinked coating. The terms “wet” and “not fully crosslinked” are used synonymously in the present application. Likewise, the terms “dry” and “crosslinked” are used synonymously in the present application.

In the context of the present invention, “heavy organic solvent” means an organic solvent miscible in water, the vapor pressure of which at 20° C. is preferably less than 4 mmHG, advantageously less than 2 mmHG.

In the present description and the claims, the terms “range comprised between A and B” or “range from A to B”, used to designate ranges of values, include the limits A and B of these ranges.

### Finishing Composition

The finishing composition for coating a metal part previously coated with a corrosion-resistant coating according to the present invention comprises at least one binder of the alkylphenylsiloxane type and glass microbeads.

Advantageously, the finishing composition comprises a content of binder of alkylphenylsiloxane type less than or equal to 30% by mass, advantageously comprised between 10% and 30% by mass, more advantageously between 15% and 18% by mass, relative to the total mass of the finishing composition. The binder content is expressed in dry matter content. In other words, the finishing composition advantageously comprises a pigment volume concentration “PVC” corresponding to the ratio (volume of [pigments+fillers])/(volume [pigments+fillers]+volume of dry binders) less than or equal to 22%, advantageously comprised between 18% and 22%.

Advantageously, the binder is of the methylphenylsiloxane type.

The inventors have discovered that, in the context of a wet-on-wet method for applying a finishing composition, the binder of the alkylphenylysiloxane type in the context of the developed formulation does not degrade and contributes to the hydrophobic properties of the complete system as well as to the resistance to strong acids and weak bases (such as 38% H₂SO₄ or 5% NaOH), and this after baking and after additional thermal shock (such as a thermal shock of 300° C. for one hour). Organic type binders such as phenoxy phenolic, phenoxy melamine, acrylic or silicate/acrylic, used in the context of a wet-on-wet method for applying a finishing composition, provide poorer chemical and thermal resistance and can cause appearance problems.

The inventors have also discovered that the presence of glass microbeads in the finishing composition also allows to limit or even avoid impregnation of the finishing composition in the base coat. The glass microbeads thus allow to reinforce the chemical resistance of the system, in particular at a low thickness of the finish.

Thus, the finishing composition advantageously comprises at least 2% by mass, more advantageously from 2% to 5% by mass, in particular from 3% to 4% by mass, in particular from 3.5% to 4.5% by mass, of glass microbeads, relative to the total mass of the finishing composition. In other words, the finishing composition advantageously comprises a content of glass microbeads greater than or equal to 6% of PVC, advantageously comprised between 6-12% of PVC, more advantageously of 10% of PVC. In this case, the unit of PVC corresponds to the ratio (volume of microbead/(volume [pigments+fillers]+volume of dry binders))

Glass microbeads are spherical shaped glass particles. Advantageously, their average diameter is comprised between 1 μm and 15 μm, preferably between 2 μm and 10 μm. The average selected diameters D50 and D95 are directly related to the maximum desired finish thickness, the selection of a D50 at 2-3 μm and a D95 at 6-8 μm correspond to finish thicknesses of up to 8 μm. The average diameters can be measured by sieving, for example.

The glass microbeads are advantageously soda-lime glass microbeads. They can in particular be treated for use in various thermoplastic or thermosetting matrices.

The inventors have also discovered that the rheology of the finishing composition according to the invention was of great importance in the context of a wet-on-wet application method. Indeed, in order to avoid the impregnation (also called interpenetration) of the finishing coat in the base coat, the finishing composition must have a ratio [Viscosity measured at 6 revolutions per minute (RPM)/Viscosity measured at 60 revolutions per minute (RPM)], called “Thixotropic index (ITh)”, greater than or equal to 3. The viscosities at 6 RPM and 60 RPM are measured according to the NF EN ISO 2555 (September 1999) method, well known to the person skilled in the art. The measurement is generally carried out at 20° C.+/−2° C. The NF EN ISO 2555 (September 1999) method consists in measuring the resistance of a rotating mobile in a sample. The value of the measured torque, the speed of rotation and the features of the mobile are combined to calculate the viscosity value, these measurements are reported in the form of graphs such as that in FIG. 3. For the finishing composition, the measurements are carried out using the Brookfield LV2 spindle and the viscosities are measured over a speed range from 3 to 60 revolutions per minute (RPM).

Advantageously, the finishing composition according to the invention also has a pseudo-plastic rheological profile (also called shear thinner) which can in particular be determined according to the same method NF EN ISO 2555 (September 1999), well known to the person skilled in the art as described above. The measurement is generally carried out at 20° C.+/−2° C.

The presence of glass microbeads in the finishing composition, associated with the Thixotropic Index ITh greater than or equal to 3, and advantageously with the pseudo-plastic profile contribute to obtaining a low impregnation rate of the finish coat in the base coat which is still wet. This further allows to improve the resistance of the final coating to salt spray, that is to say to improve the cathodic protection of the coating, in particular of the corrosion-resistant coating.

The pseudo-plastic behavior of an aqueous phase coating composition can further be achieved by the addition of thickening agents well known to the person skilled in the art.

Among the thickening agents intended for water-based paints, in particular mention will be made of:
Thickeners such as bentonites or montmorillonites (generally modified by organic molecules). These rather confer a thixotropic behaviour.
Pyrogenic silicas. These are well known to impart a gelled structure.
Non-associative thickeners such as polysaccharides (for example xanthan gum, cellulose derivatives, some copolymers of acrylic acid). These thickeners rather impart a pseudo-plastic behavior (shear thinner) without thixotropy.
Associative thickeners such as, for example, ethoxylated urethane thickeners or else hydrophobic modified acrylic thickeners or else etherified cellulosic polymers. These thickeners generally involve being neutralized by a base when incorporated into the composition in the aqueous phase.
Cellulose nano or microfibrils (CNMF) which can provide the compositions in the aqueous phase with very interesting pseudo-plastic (shear-thinning) behavior. These CNMFs can, for example, be in the form of “platelets” with a maximum average size of at least 10 microns and a minimum average size of less than 1 micron as described in patent WO2013128196A1.

Advantageously, the xanthan gum/CNMF pair is used as a thickener in the context of the present invention. Advantageously, the xanthan gum/CNMF mass ratio is comprised between 45/10 and 15/10, advantageously between 30/10 and 15/10, more advantageously between 30/10 and 20/10. Advantageously, the xanthan gum/CNMF mass ratio is 45/10, preferably 30/10, preferably 20/10. The combined use of the xanthan gum/CNMF pair and glass microbeads thus allows to obtain an impregnation rate of the finishing composition in the base coat, which is still wet, of less than 10%. The impregnation rate of the finishing composition in the base coat corresponds to the amount of finishing composition which penetrates into the base coat and which is therefore no longer on the surface of the substrate/base coat/base finishing coat system, relative to the total amount of the finishing composition applied to the system. This impregnation rate can be measured by techniques known to the person skilled in the art, such as analysis of the content of silica element (present in the binder of alkylphenylsiloxane type) present on the surface of the system by X-ray fluorescence.

Advantageously, the finishing composition according to the invention further comprises filler particles with a high thermal resistance and/or particulate aluminum. High thermal resistance filler particles are characterized by thermal resistance of at least 500° C. Said high thermal resistance filler particles are advantageously selected from boron nitride powders or potassium titanates in lamellar form. The high thermal resistance filler particles advantageously present in the finishing composition generally contribute to the thermal protection of the system.

Advantageously, the finishing composition according to the invention comprises a particulate aluminum, in particular lamellar aluminum particles, which, in addition to thermal protection, provide the expected aesthetic appearance, in particular a silver-type color, for a coating of a metal part. Particulate aluminum, in particular lamellar particulate aluminum, advantageously has a granulometry of less than 100 μm, even more advantageously less than 40 μm. Advantageously, the content of particulate aluminum, in particular of lamellar aluminum particles, in the finishing composition (liquid) will not exceed about 10% by mass, relative to the total mass of the finishing composition to maintain the best coating appearance. More advantageously, the content of particulate metal will represent from 3% to 10% by mass, more advantageously between 3% and 5% by mass relative to the total mass of the finishing composition. In other words, the finishing composition advantageously comprises a content of aluminum particles, in particular of lamellar aluminum particles, greater than or equal to 6% PVC, advantageously between 6-12% PVC, more advantageously 10% PVC. In this case, the unit PVC corresponds to the ratio (volume of aluminum particles/(volume [pigments+fillers]+volume of dry binders)).

Advantageously, the finishing composition according to the invention can further comprise a wetting agent. Such suitable wetting agents can be, for example, a nonionic ethoxylated acetylenic surfactant such as ethoxylated 2,4,7,9-tetramethyl-5-decyne-4,7-diol. The content of the wetting agent is advantageously from 0.01% to 3% by mass, more advantageously from 0.01% to 1% by mass, relative to the total mass of the finishing composition.

Advantageously, the finishing composition according to the invention can further comprise a dispersing agent, in particular selected, for example, from acrylic copolymers. Advantageously, the dispersing agents of the BYK® brand are used. The content of the dispersing agent is advantageously from 0.01% to 3% by mass, more advantageously from 0.01% to 1% by mass, relative to the total mass of the finishing composition.

Advantageously, the finishing composition according to the invention can further comprise a pigment preferably of mineral type, advantageously in a content of 1% to 10% by mass, advantageously of 4% to 5% by mass, relative to the total mass of the finishing composition. The addition, for example, of lamellar particles of potassium titanate or of boron nitride particles can allow to reinforce the thermal resistance of the coating.

Advantageously, the finishing composition according to the invention is chromium-free. “Chromium-free” means that the composition does not contain hexavalent chromium as may be represented by chromic acid or dichromates.

Advantageously, the finishing composition according to the invention can further comprise a heavy organic solvent.

The addition of heavy organic solvent will have an impact on the duration of the drying and baking steps and therefore on the total duration of the coating application method. Consequently, the content of heavy organic solvent in the finishing composition according to the invention can be adapted depending on the type of desired method: in methods for which it is desired to reduce the total time, it is possible to reduce the duration of the drying and/or baking step by adding a high content of heavy organic solvent; on the other hand, in methods for which the environmental impact takes precedence over the total duration, a zero or low content of heavy organic solvent will be preferred.

Advantageously, the content of heavy organic solvent in the finishing composition according to the invention is from 0.01% to 40%.

Advantageously according to a first aspect of the invention, the content of heavy organic solvent in the finishing composition according to the invention is from 0.01% to 35%, more advantageously from 0.01% to 30%, more advantageously from 0.01% to 25%, more advantageously from 0.01% to 20%, even more advantageously from 1% to 20%, by mass relative to the total mass of the finishing composition.

Advantageously according to a second aspect of the invention, the content of heavy organic solvent in the finishing composition according to the invention is from 1% to 40%, more advantageously from 20% to 40%, more advantageously from 21% to 40%, more advantageously 25% to 40%, even more advantageously 30% to 40%, by mass relative to the total mass of the finishing composition.

Advantageously, as a heavy organic solvent, it is possible in particular to use glycolic solvents such as glycol ethers, in particular monoethylene glycol, diethylene glycol, triethylene glycol and dipropylene glycol, acetates, propylene glycol, polypropylene glycol, propylene glycol methyl ether, and mixtures thereof. Preferably, in the context of the present invention, glycolic solvents will be used such as glycol ethers, and in particular monoethylene glycol, dipropylene glycol or triethylene glycol.

In summary, the finishing composition according to the invention advantageously comprises (in % expressed by mass relative to the total mass of the final composition):
From 10% to 30% by mass of a binder of alkylphenylsiloxane type, more advantageously from 15% to 18% by mass, expressed by its dry matter content;
From 2% to 5% by mass of glass microbeads, more advantageously from 3.5% to 4.5% by mass;
From 0% to 10% by mass of particulate aluminum, more advantageously between 3% and 10% by mass, in particular between 3% and 5% by mass;
From 30 to 70% by mass of water, more advantageously from 40 to 60% by mass;
Optionally from 0.2% to 1%, advantageously from 0.25% to 0.9% by mass of thickening agent, in particular from 0.30% to 0.40% by mass of a xanthan gum/CNMF mixture (20:10);
Optionally, from 0.01% to 3% by mass of a wetting agent, advantageously from 0.01% to 1% by mass;
Optionally, from 0.01% to 3% by mass of a dispersing agent, advantageously from 0.01% to 1% by mass; and
Optionally, from 1% to 10% by mass of a preferentially mineral pigment, advantageously from 4% to 5% by mass;
Optionally, from 0.01% to 40%, by mass of a heavy organic solvent of monoethylene glycol, dipropylene glycol or triethylene glycol type, more advantageously from 1% to 20%, each of these ingredients being as defined above.

According to another embodiment, the finishing composition according to the invention advantageously comprises (in % expressed by mass relative to the total mass of the final composition):
From 10% to 30% by mass of a binder of alkylphenylsiloxane type, more advantageously from 15% to 18% by mass;
From 2% to 5% by mass of glass microbeads, more advantageously from 3% to 4% by mass, relative to the total mass of the finishing composition;
From 0% to 10% by mass of particulate aluminum, more advantageously between 3% and 10% by mass, in particular between 3% and 5% by mass;
Optionally from 0.5% to 1% by mass of thickening agent, in particular from 0.40% to 0.60% by mass of a xanthan gum/CNMF mixture (30:10);
Optionally, from 0.01% to 3% by mass of a wetting agent, advantageously from 0.01% to 1% by mass;
Optionally, from 0.01% to 3% by mass of a dispersing agent, advantageously from 0.01% to 1% by mass; and
Optionally, from 1% to 10% by mass of a preferably mineral pigment, advantageously from 4% to 5% by mass,
Optionally, from 0.01% to 40%, by mass of a heavy organic solvent of monoethylene glycol, dipropylene glycol or triethylene glycol type, more advantageously from 1% to 20%,
   each of these ingredients being as defined above.

### Corrosion-Resistant Coating

A second object of the present invention is a corrosion-resistant coating for a metal part comprising at least two coats different from each other, the first coat being a base coat comprising at least water, a particulate metal and a binder, and the second coat being a finishing composition as defined above.

According to the invention, the corrosion-resistant coating of metal parts is applied to the metal parts to be protected, with a uniform total wet thickness advantageously comprised between 11 μm and 195 μm wet corresponding to a uniform dry thickness advantageously comprised between 2 μm and 35 μm, more advantageously between 30 μm and 140 μm wet corresponding to a uniform dry thickness advantageously comprised between 5 μm and 25 μm, more advantageously between 55 μm and 111 μm wet corresponding to a thickness between 10 μm and 20 μm dry, more advantageously between 55 μm and 110 μm wet corresponding to a thickness between 10 μm and 20 μm dry, even more advantageously between 55 μm and 85 μm wet corresponding to a dry thickness between 10 μm and 15 μm.

In particular, the wet thickness of the finishing of the corrosion-resistant coating according to the invention is advantageously comprised between 6 μm and 65 μm corresponding to a dry thickness comprised between 1 μm and 12 μm, more advantageously between 12 μm and 65 μm corresponding to a dry thickness comprised between 2 μm and 12 μm, more advantageously between 6 μm and 60 μm corresponding to a dry thickness comprised between 1 μm and 10 μm, more advantageously between 12 μm and 35 μm corresponding to a dry thickness comprised between 2 μm and 6 μm, more advantageously the thickness of the wet finish of the coating should be comprised between 6 μm and 35 μm corresponding to a dry finish thickness comprised between 1 μm and 6 μm, more advantageously between 12 μm and 35 μm corresponding to a dry thickness comprised between 2 μm and 6 μm.

The corrosion-resistant coating according to the invention provides the metal part to which it is applied, with a protection against corrosion, in particular cathodic protection, and chemical resistance, in particular resistance to chemical aggression, in particular to strong acids and/or weak bases.

Advantageously, the base coat composition is a composition for a corrosion-resistant coating with aqueous dispersion, advantageously free of chromium, comprising, jointly with the aqueous medium:
A particulate metal,
A binder
Optionally an organic liquid,
Optionally a thickener; and
Optionally a wetting agent.

The particulate metal is advantageously selected from the group consisting of zinc, aluminum, chromium, manganese, nickel, titanium, alloys and intermetallic mixtures thereof, as well as mixtures thereof. The particulate metal is advantageously selected from zinc and aluminum, as well as alloys thereof and mixtures thereof or their alloys with manganese, magnesium, tin or Galfan®. The particulate metal present in the composition is advantageously in the form of a lamellar powder. The particulate metal is advantageously selected from lamellar zinc and/or lamellar aluminum, and preferably comprises lamellar zinc. The particulate metal advantageously has a granulometry of less than 100 μm, even more advantageously less than 40 μm. The content of particulate metal of the base coat composition will not exceed about 35% by mass of the total mass of the base coat composition to maintain the best coating appearance. Advantageously, the particulate metal content will represent from 1.5% to 35% by mass, more advantageously between 10% and 35% by mass, relative to the total mass of the base coat composition.

The base coat composition advantageously comprises from 3% to 50% by mass, relative to the total mass of the base coat, of binder. The binder is advantageously selected from silane-based binders, titanate-based binders, zirconate-based binders, silicate-based binders, and binders based on phenoxy resins in the aqueous phase crosslinked for example by a melamine. In a variant of the invention, the base coat advantageously comprises from 3% to 35% by mass, more advantageously 3% to 25% by mass, relative to the total mass of the base coat, of binder. The binder is then advantageously selected from silane-based binders, titanate- based binders, zirconate-based binders, and mixtures thereof, in particular in pairs. In particular, the binder can be a mixture of silane and titanate. The silane-based binders are described in international application WO 2017/042483, in particular from line 26 page 3 to line 17 page 4. The titanate-based binders are described in international application WO2017/042483 from line 19 page 4 to line 16 page 5 and in the filing of patent application N° 1761267 from line 19 of page 3 to line 17 of page 4. Zirconate-based binders are described in international application WO2017/042483 from line 17 page 5 to line 14 page 6. Finally, the silicate-based binders are described in international application WO2017/042483 page 6, from line 15 to line 22.

Advantageously, the base coat composition can further comprise an organic liquid. As organic liquid, it is possible in particular to use glycolic solvents such as glycol ethers, in particular diethylene glycol, triethylene glycol and dipropylene glycol, acetates, propylene glycol, polypropylene glycol, nitropropane, alcohols, ketones, propylene glycol methyl ether, 2,2,4-trimethyl-pentanediol (1,3) (texanol) isobutyrate, white spirit as well as mixtures thereof. Dipropylene glycol is particularly advantageous, in particular for economic and environmental reasons. As an organic solvent, it is also possible to use esters, such as ethyl lactate, methyl oleate or methyl- or ethyl-esters of fatty acids. When an organic liquid is present in the base coat, it will be present in an amount of 1% to 30% by mass, calculated on the total mass of the composition. The presence of the organic liquid, in particular in amounts greater than 10% by mass, for example from 15% to 25% by mass, can improve the corrosion resistance of the coating, but the use of amounts greater than about 30% by mass can become uneconomical.

Advantageously, the base coat composition can further comprise a thickening agent, in particular in a content comprised between 0.05% and 2.00% by mass of thickener. The thickeners that can be used in the base coat composition are described in European application EP 0 808 883 from column 4, line 52 to column 5, line 25.

Advantageously, the base coat composition may further comprise a wetting agent, in particular in a content of 0.01% to 3% by mass, relative to the total mass of the base coat composition. Such suitable wetting agents comprise nonionic polyethoxylated alkylphenol addition products, as an example. Likewise, esters of anionic organic phosphates can be used.

The base coat composition can optionally comprise other ingredients such as a pH modifier, or phosphates. These other ingredients are also described in European application EP 0 808 883.

Wet-on-Wet Application Method

A third object of the present invention relates to a method for applying a corrosion-resistant coating as defined above on a metal substrate, said method comprising a step of applying said finishing composition to said first base coat previously applied to the metal substrate, characterized in that said base coat is still wet during the application of the finishing composition. This type of method is called a wet-on-wet method and can be represented, for example, by the diagram of FIG. 1A.

The method according to the invention has the specific feature of not requiring a step of baking/crosslinking the base coat before applying the finishing coat.

The base coat can be applied to the metal substrate by various techniques such as for example immersion/emersion techniques with or without moving the parts to be treated, when the parts to be treated are compatible with these processes. It is also considered to use a spray technique as well as combinations such as spinning spray. Advantageously, the base coat is applied to the metal substrate by spraying.

Advantageously, the base coat is applied to the metal parts to be protected, with a uniform total wet thickness advantageously comprised between 11 μm and 195 μm wet corresponding to a uniform dry thickness advantageously comprised between 2 μm and 35 μm, more advantageously between 30 μm and 140 μm wet corresponding to a uniform dry thickness advantageously comprised between 5 μm and 25 μm, more advantageously between 55 μm and 111 μm wet corresponding to a thickness between 10 and 20 μm dry, more advantageously between 55 μm and 110 μm wet corresponding to a thickness between 10 μm and 20 μm dry, even more advantageously between 55 μm and 85 μm, corresponding to a dry thickness between 10 μm and 15 μm.

The finishing coat is then applied to the base coat that is still wet (that is to say before baking/crosslinking) preferably by spraying. The spraying technique is known to the person skilled in the art and can be combined with a spinning of the metal substrate.

Advantageously, the finishing coat is applied to the base coat at a wet thickness comprised between 6 μm and 65 μm corresponding to a dry thickness comprised between 1 μm and 12 μm, more advantageously between 12 μm and 65 μm corresponding to a dry thickness comprised between 2 μm and 12 μm, more advantageously between 6 μm and 60 μm corresponding to a dry thickness comprised between 1 μm and 10 μm, more advantageously to a wet thickness between 6 μm and 35 μm corresponding to a dry thickness comprised between 1 μm and 6 μm, more advantageously between 12 μm and 35 μm corresponding to a dry thickness comprised between 2 μm and 6 μm.

Between the step of applying the base coat and the step of applying the finishing coat, a pause time is advantageously carried out. This pause time should not exceed 50 seconds in order to avoid the appearance of blistering on the surface of the system when it is baked, making the appearance of the coating non-compliant. The maximum pause time can be adapted according to the thickness of the base coat. For example, for a base coat having a wet thickness of 60 μm corresponding to a dry thickness of about 10 μm, the maximum pause time will be 40 seconds, beyond this time, the appearance of bubbling will make the appearance of the film non-compliant and will decrease the performance of the applied system. Advantageously, the pause time between the application of the base coat on the metal substrate and the application of the finishing composition on the base coat is comprised between 5 seconds and 40 seconds, more advantageously between 10 seconds and 20 seconds. This pause time plays a role in the corrosion resistance after chemical exposure of the coated metal part and in the final appearance of the coating. This pause time thus allows to reinforce the protection of the coating against chemical aggression, in particular against strong acids and weak bases, and thermal aggression.

Advantageously, the method according to the invention comprises a first step of preheating the metal substrate before application of the base coat. The metal substrate is then advantageously preheated to a temperature greater than 36° C., advantageously greater than 40° C., advantageously at a temperature comprised between 36° C. and 65° C., more advantageously comprised between 40° C. and 65° C., in particular comprised between 40° C. and 55° C. The prior preheating of the metal substrate also contributes to the protection of the coating against chemical aggression, in particular against strong acids and weak bases, and thermal aggression.

After the application of the finishing coat, the coating compositions are then subjected to a baking operation carried out preferably at a temperature comprised between 280° C. and 400° C., preferably at a temperature comprised between 310° C. and 350° C.

The baking operation can be carried out, for approximately 20 minutes to 40 minutes once the selected metal temperature has been reached, by supplying thermal energy, such as by convection, or during a baking cycle comprised between 30 seconds and 5 minutes by induction.

According to an advantageous embodiment, prior to the baking operation, the coated metal parts are subjected to a drying operation, preferably at a temperature comprised between 50° C. and 130° C. The operation of drying the coated metal parts can be carried out by supplying thermal energy, such as by convection, infrared and/or induction, at a defined temperature and temperature ramp, advantageously between 70° C. and 110° C., in on-line convection or infra-red and/or induction. Such a drying operation allows to prevent the appearance of defects on the surface of the coating, such as blistering.

Before applying the coating composition, in most cases it is a good idea to remove the foreign material from the surface of the substrate, in particular by thoroughly cleaning, degreasing and rinsing. Degreasing can be achieved with known agents, for example with agents containing sodium metasilicate, caustic soda, carbon tetrachloride, trichlorethylene and the like. Commercial alkaline cleaning compositions which combine moderate washing and abrasion treatments can be used for cleaning, for example, aqueous sodium hydroxide-trisodium phosphate cleaning solution. In addition to cleaning, the substrate may undergo cleaning plus etching.

The present invention also relates to a corrosion-resistant coating of metal parts that can be obtained by the wet-on-wet type method described above.

### Coated Metal Substrate

An object of the present invention is also a metal substrate coated with a corrosion-resistant coating as defined above or capable of being obtained by the method described above.

The substrate is metallic (also called a metallic part), preferably made of steel or cast iron, or steel or cast iron coated with zinc or a zinc-based coat deposited by different modes of application including mechanical deposition, at the cast iron and aluminum. Advantageously, the metal substrate is made of cast iron or cast iron coated with zinc.

The metal substrate according to the invention is therefore coated with at least one base coat as defined above and a finish coat according to the invention as defined above; these two coats forming the corrosion-resistant coating according to the invention and having undergone a single baking step resulting in their hardening/crosslinking.

Advantageously, the metal substrate is coated with the corrosion-resistant coating of metal parts in a uniform manner and with a total dry thickness comprised between 2 μm and 35 μm, advantageously between 6 μm to 35 μm, more advantageously between 8 μm and 30 μm, more advantageously between 11 μm to 30 μm, even more advantageously between 11 μm to 21 μm, even more advantageously between 10 μm to 20 μm.

The metal substrate can be degreased prior to the application of the coatings, by methods known to the person skilled in the art, in particular by alkaline degreasing.

### DESCRIPTION OF FIGURES

FIG. 1 shows the different methods for applying a coating composition in one or two coats:

FIG. 1A shows an advantageous “wet-on-wet” application method comprising a step al) of preheating the substrate to 40-55° C., a step a2) of applying the base coat, a step a3) with a pause time of 10 to 20 seconds, a step a4) of spraying the finishing composition, a drying step a5) and a step a6) of baking at about 340° C.

FIG. 1B shows the “wet-on-dry” application method by convection comprising a step b1) of applying the base coat, a step b2) of drying by infrared at about 30° C. (or drying by heat supply by convection at 70° C.) for 15 min metal temperature followed by cooling to a temperature below 30° C., a step b3) of spraying the finishing composition, a step b4) of drying at about 70° C. by convection and a step b5) of baking at about 340° C.

FIG. 1C shows the “two-coat two-bake” application method comprising a step c1) of applying the base coat, a step c2) of drying at 70° C. followed by baking at about 340° C. by induction, a step c3) of cooling to about 20° C., a step c4) of spraying the finishing composition and a step c5) of drying at 70° C. followed by baking at about 340° C. by induction.

FIG. 1D shows the “one-coat” application method comprising a step d1) of applying the base coat and a step d2) of drying at 70° C. and then baking at 340° C.

FIG. 2 shows the metal portions coated with a coating the finishing composition of which is composition B1 (comprising an organic binder) (FIGS. 2A to 2C) or the finishing composition of which is composition A1 (FIG. 2D)

FIG. 3 shows the rheological profiles of the finish coats A2 and B2.

FIG. 4 shows a metal part coated with a coating the finishing composition of which is A2 (FIG. 4A) or B2 (FIG. 4B), after exposure to salt spray for 120 h (FIG. 4A) or 72 h (FIG. 4B).

FIG. 5 schematically shows the impregnation and measurement of the impregnation rate of the finishing coat in the base coat for a finishing composition of Newtonian rheological profile in the absence of glass microbeads (FIG. 5A), a finishing composition of pseudoplastic rheological profile having a ratio [Viscosity measured at 6 revolutions per minute (RPM)/Viscosity measured at 60 revolutions per minute (RPM)], called “Thixotropic index (ITh)”, greater than or equal to 3 and in the absence of glass microbeads (FIG. 5B), and a finishing composition of a pseudoplastic rheological profile having a “Thixotropic index (ITh)” ratio greater than or equal to 3 and in the presence of glass microbeads (FIG. 5C).

FIG. 6 shows a metal substrate of the coated cast iron type comprising a single base coat (FIG. 6A) after various thermal shocks and having been exposed to salt spray and FIG. 6B showing the complete base coat and finishing composition system tested under the same conditions.

### EXEMAPLES

The examples which follow illustrate the present invention without limitation.

Ingredients Used

stapa PG chromal VIII® aluminum at 80%=aluminum powder marketed by Eckart Werke (AI dry extract: 80% by weight)

Kelzan AR®=xanthan gum

Silbercote AQ2169gF3X® (Supplier SILBERLINE)=Inhibited aluminum paste

Spheriglass 7010 CP01®=Soda-lime glass bead

Silres MP50E®=Silicone phenyl dispersion

Excilvia® (supplier BORREGAARD SA)=Nano or micro cellulose fibrils (CNMF)

Fintalc MO5®=Talc

PKHW35®=Phenoxy resin

Cymel 3717®=Melamine resin

Experimental Protocols

In the following examples, the following application and measurement protocols have been implemented:

Preparation of Test Parts

Unless otherwise specified, the test parts are cold rolled metal plates (LAF) 30 cm×12 cm or cast iron brake discs. These parts generally receive an alkaline degreasing operation before the coating is applied.

As examples of the alkaline degreasing method used, mention can be made of:
For LAF plates:
   Degreasing by immersion in an alkaline degreaser bath of Bonderite C AK C-32 type
      Concentration 50 to 60 gr/liter
      Operating temperature 80-95° C.
      Immersion time 5-12 minutes
   “Dead” rinse at a temperature of 50° C.
   Surface rubbed with a fibrous pad of synthetic fibers impregnated with an abrasive
   Mains water cascade rinsing
   Drying with compressed air
For cast iron brake discs:
   Degreasing by immersion in an alkaline degreaser bath Bonderite C AK C-32 type
      Concentration 50 to 60 gr/liter
      Operating temperature 80-95° C.
      Immersion time 20-40 minutes
   “Dead” rinse 50° C.
   Surface rubbed with a sponge type pad
   Mains water cascade rinsing
   Drying with compressed air

Application of the Base Composition to the Test Portions

The clean portions are typically coated by spraying the base coating composition thereon, optionally with moderate spinning action. The base composition is as described in the following Table 1:

TABLE 1
Base composition

| Ingredient | % mass | Description |
|---|---|---|
| Stapa PG Chromal VIII Alu at 80% | 10.44% | Lamellar aluminum in |
| | | Dipropylene glycol |
| γ-Glycidoxypropyltrimethoxysilane | 8.67% | Binder |
| Dipropylene Glycol | 8.42% | Heavy solvent |
| Deionized water | 42.40% | Eluent |
| Zinc paste 31129/G/92 | 25.22% | Lamellar zinc in white |
| | | spirit |
| Additives | 4.86% | Antifoam, spreading |
| | | agent, passivator, |
| | | rheological, dispersant |
| | | additives |

Application of the finishing composition to the test portions coated with the base coat The test portions previously coated with the base coat are then coated with the finishing coat by spraying, optionally with a moderate spinning action. The finishing composition is as described in Table 2 below:

TABLE 2
Finishing composition

| Ingredient | % mass | Description |
|---|---|---|
| Deionized water | 54.25% | Eluent |
| Kelzan AR ® | 0.23% | Xanthan gum-type thickener |
| Spheriglass 7010 CP01 ® | 4.16% | Soda-lime glass beads |
| Silbercoat AQ2169gF3X ® | 9.24% | Passivated lamellar aluminum |
| Exclivia ® 100% dry matter | 0.12% | Cellulosic thickener CNMF |
| Silres MP50E ® 50% dry matter | 31.80% | Phenylmethylsilicone |
| | | dispersion |
| Additives | 0.20% | Antifoam additives and |
| | | surfactants |

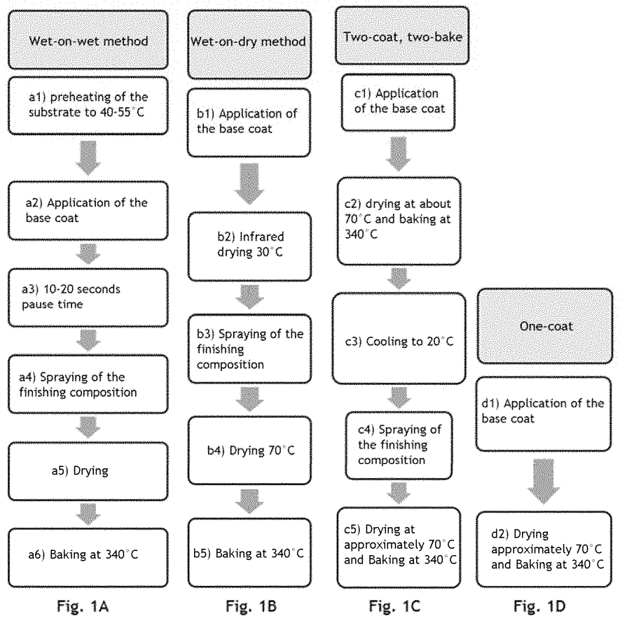

The test portions thus coated are then subjected to immediate baking or with prior drying. The baking takes place in a hot air convection oven, at the temperatures and durations indicated in the examples and in FIGS. 1A to 1D. The drying between the two coats can take place under infrared exposure for 30 seconds.

Corrosion Resistance Test (ASTM B117) and Estimation

Corrosion resistance of coated portions is measured using the standard salt splash (spray) test for ASTM B-117 paints and varnishes. In this test, the portions are placed in a chamber maintained at a constant temperature where they are exposed to a fine splash (spray) of 5 percent saline solution for specific periods of time, rinsed with water and dried. The extent of corrosion of the tested portions can be expressed as the percentage of red rust. For a test panel portion containing a deformed tapered mandrel (elbow) portion, elbow corrosion can also be expressed as a percent red rust. Initially, after coating and bending, a pressure sensitive tape is applied to the elbow. The tape is then quickly removed from the elbow. This is done to determine the adhesion of the coating. The panel is then subjected to the corrosion resistance test.

Test of Resistance to Chemical Aggression

The resistance to chemical aggression of the coated portions is measured by means of exposure to various rim cleaners for 10 or 30 minutes, rinsing and exposure to salt spray (SST) as described above.

The rim cleaners tested are:
Sineo™ (pH 13)—SADAPS BARDAHL additives and lubricants
Aluminum Teufel (pH<1)—TUGA Chemie Gmbh
Neutral Cleaner (pH 8).

### Example 1

### Comparison of the Various Treatment Methods

The various methods described in FIGS. 1A to 1D are implemented on a substrate of the cast iron type. The appearance of rust, energy consumption and the time of treatment of the parts are then compared (Table 3). The base and finish coats used are identical.

TABLE 3

| | | Time before | Time before | | |
|---|---|---|---|---|---|
| | | rust appears on | rust appears on | % additional | Additional |
| | Total | portions | portions not | energy (kWh) | treatment time |
| | thickness | exposed to | exposed to | vs 1 coat-1 | vs 1 coat-1 |
| Method used | of the | chemical | chemical | bake method | bake method |
| on a disc | coating | aggression | aggression | (for a 10 kg disc) | (for a 10 kg disc) |
| “Wet-on-wet” | 14-16 μm | 336 h | 336 h | +50% relative | +30-40 seconds |
| method | | | | to the reference | |
| according to | | | | | |
| the invention | | | | | |
| FIG. 1A | | | | | |
| “Wet-on-dry” | 14-16 μm | 264 h | 264 h | +30% relative | +11 minutes |
| method | | | | to the reference | |
| FIG. 1B | | | | | |
| Two-coat, two- | 14-16 μm | 456 h | 456 h | +110% relative | At least twice |
| bake method | | | | to reference | as long |
| FIG. 1C | | | | | |
| “One coat - one | 10-12 μm | 48 h | 504 h | Reference | Reference |
| bake” method | | | | | |
| FIG. 1D | | | | | |

The coating obtained by the “one-coat” method (FIG. 1D) gives the substrate only cathodic protection properties. It is not resistant to strong acids and/or strong bases.

### Example 2

### Comparison of an Alkylphenylsiloxane Type Binder and an Organic Type Binder in the Finishing Composition

For this example, each of the finishing compositions was spray applied to a cold rolled metal type substrate coated with the base coat of Example 1. After the final baking, the treated metal substrate is subjected to one or two chemical attacks: 38% hydrochloric acid and 5% NaOH. The appearance of the substrate (visual degradation) is then analyzed.
a) Composition A1 according to the invention (comprising a methylphenylsiloxane binder) (Table

TABLE 4

| Ingredient | % mass | Description |
|---|---|---|
| Deionized water | 54.25% | Eluent |
| Kelzan AR ® | 0.23% | Xanthan gum thickener |
| Spheriglass 7010 CP01 ® | 4.16% | Soda-lime glass beads |
| Silbercoat AQ2169gF3X ® | 9.24% | Passivated lamellar aluminum |
| Exclivia ® 100% dry matter | 0.12% | Cellulosic thickener CNMF |
| Silres MP50E ® 50% dry matter | 31.80% | Phenylmethylsilicone |
| | | dispersion |
| Additives | 0.20% | Antifoam additives and |
| | | surfactants |

b) Composition B1 comprising a binder of thermosetting organic type (Table 5.)

TABLE 5

| Ingredient | % mass | Description |
|---|---|---|
| Deionized water | 33.31% | Eluent |
| Talc (Fintalc MO5 ®) | 6.41% | Mineral filler |
| Phenoxy resin (PKHW35 ®) | 52.71% | Binder 35% dry matter |
| Melamine resin (Cymel 3717 ®) | 6.09% | Melamine-type crosslinking |
| | | agent |
| Additives | 1.48% | Surface tension agent |

c) Results after chemical attack (Table 6.)

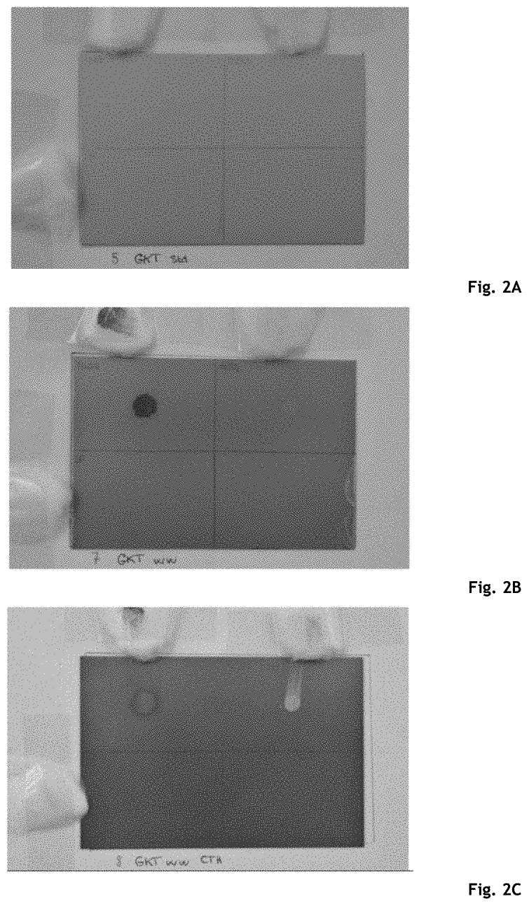

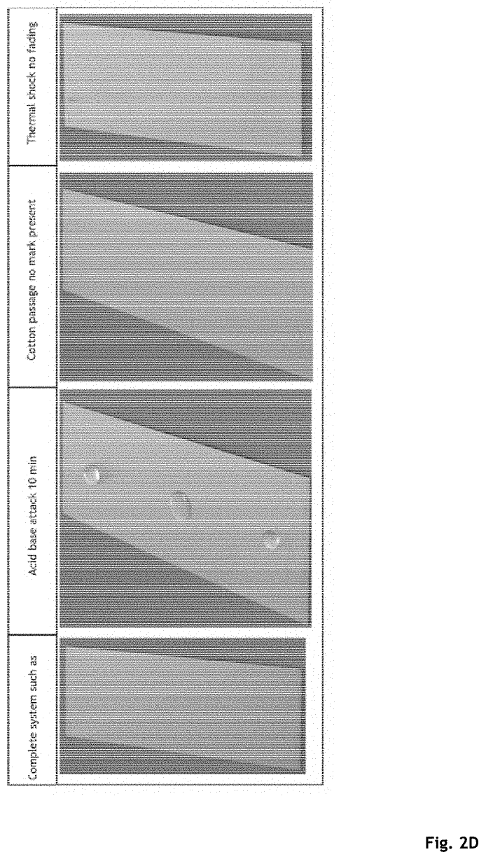

TABLE 6

| | | | Results |
|---|---|---|---|
| | | Finishing | after |
| | | composition | chemical |
| | Method used | used | attack |
| Case | Two-coat and two-bake, (310° C. for | Composition | FIG. 2A |
| 1 | the base coat, 180° C. for the finish | B1 | |
| | coat) | | |
| Case | Two-coat and one-bake 310° C. with | Composition | FIG. 2B |
| 2 | intermediate drying period | B1 | |
| Case | Two-coat and one-bake 310° C. with an | Composition | FIG. 2C |
| 3 | intermediate drying period, followed by | B1 | |
| | a thermal shock | | |
| Case | Two-coat and one-bake 310° C. with | Composition | FIG. 2D |
| 4 | intermediate drying period | A1 | |

This study shows that an organic type system after baking at 310° C. (cases 2 and 3) followed by a thermal shock does not maintain its initial appearance and, above all, no longer allows it to play its role of protection against chemical agents.

The appearance degradation in cases 2 and 3 (two-coat one-bake) is accompanied by a loss of chemical resistance and a loss of the hydrophobic character of the system. In case 3, the total consumption of zinc in the system after chemical attack no longer ensures the cathodic protection of the complete system. In case 4 with the use of composition A1, no degradation of the coating is observed after chemical attack, such as and after thermal shock 300° C. 1H. Composition A1 therefore allows to protect the Zinc present in the base coat and thus to maintain the cathodic protection of the complete system.

### Example 3

### Influence of the Controlled Rheology of the Finishing Composition

a) Finishing composition A2 comprising the xanthan gum/CNMF pair as thickener (Table 7.)

TABLE 7

| Ingredient | % mass | Description |
|---|---|---|
| Deionized water | 54.25% | Eluent |
| Kelzan AR ® | 0.23% | Xanthan gum thickener |
| Spheriglass 7010 CP01 ® | 4.16% | Soda-lime glass beads |
| Silbercoat AQ2169gF3X ® | 9.24% | Passivated lamellar aluminum |
| Exclivia ® 100% dry matter | 0.12% | Cellulosic thickener CNMF |
| Silres MP50E ® 50% dry matter | 31.80% | Phenylmethylsilicone |
| | | dispersion |
| Additives | 0.20% | Antifoam additives and |
| | | surfactants |

b) B2 finishing composition comprising a conventional thickener (Natrosol 330+) (Table 8.)

TABLE 8

| Ingredient | % mass | Description |
|---|---|---|
| Deionized water | 54.15% | Eluent |
| Natrosol 330+ ® | 0.45% | Cellulose-type thickener |
| MICA TF ® | 4.16% | Mineral filler |
| Silbercoat AQ2169gF3X ® | 9.24% | Passivated lamellar aluminum |
| Silres MP50E ® 50% dry matter | 31.80% | Phenylmethylsilicone |
| | | dispersion |
| Additives | 0.20% | Antifoam additives and |
| | | surfactants |

c) Analysis of the influence of rheology on impregnation

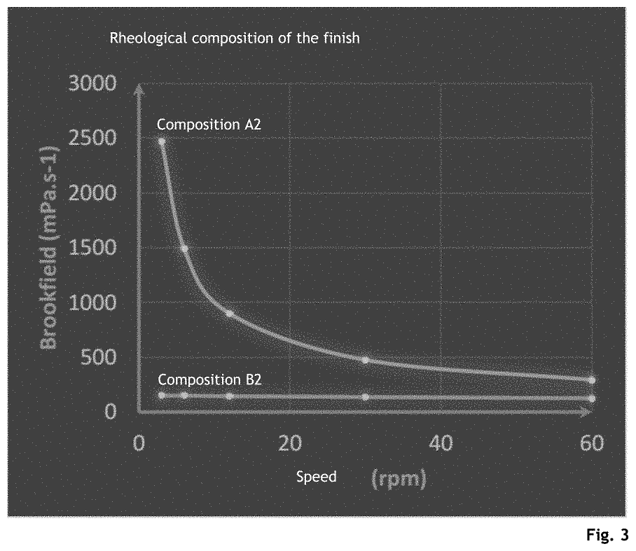

The rheology of the compositions was measured according to the following method: NF EN ISO 2555 (September 1999) which consists in measuring the resistance of a rotating mobile in a sample. The measured torque, the speed of rotation and the features of the mobile are combined to calculate the viscosity value, these measurements are reported in the form of graphs such as FIG. 3, the measurement is carried out at 20° C.+or −2. For the composition, these values are determined using the Brookfield LV2 spindle and the viscosities are measured over a speed range defined between 3 and 60 RPM.

The profiles obtained are shown in FIG. 3. Composition A2 has a pseudo-plastic profile and a thixotropic index greater than or equal to 3, while composition B2 has a Newtonian profile and a thixotropic index less than 3.

Each of the finishing compositions was then applied by spraying onto a substrate of the cast iron type and coated with the base coat of Example 1. Impregnation can then be controlled according to one of the following two methods:
by X-ray fluorescence: the silica element present in the finishing composition is masked during its impregnation in a medium rich in zinc, it is then detectable only at the surface of the system, which allows to evaluate its positioning in the complete system. Use of the X-Ray NITON GOLD++handheld device;
by exposure to salt spray (SST): the second possibility consists in exposing the complete system to salt spray in order to evaluate the performance in cathodic protection. By impregnating itself, the finishing composition will act as an insulator with regard to the zinc and greatly degrade the corrosion-resistant performance of the system (decrease in the cathodic protection of the system).

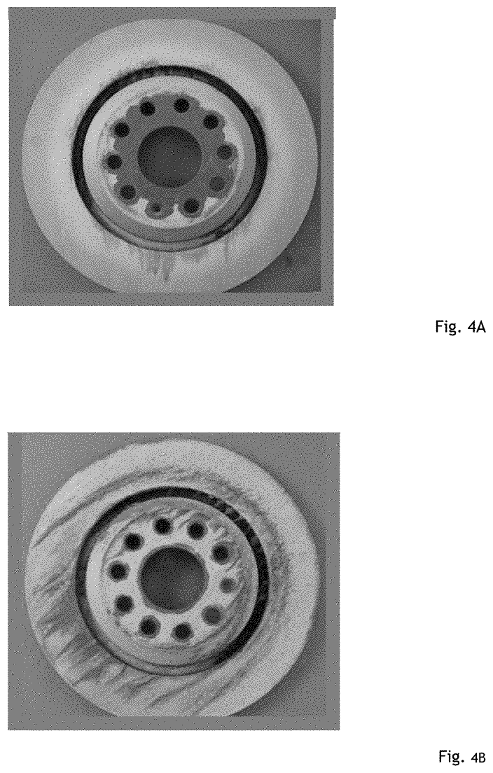

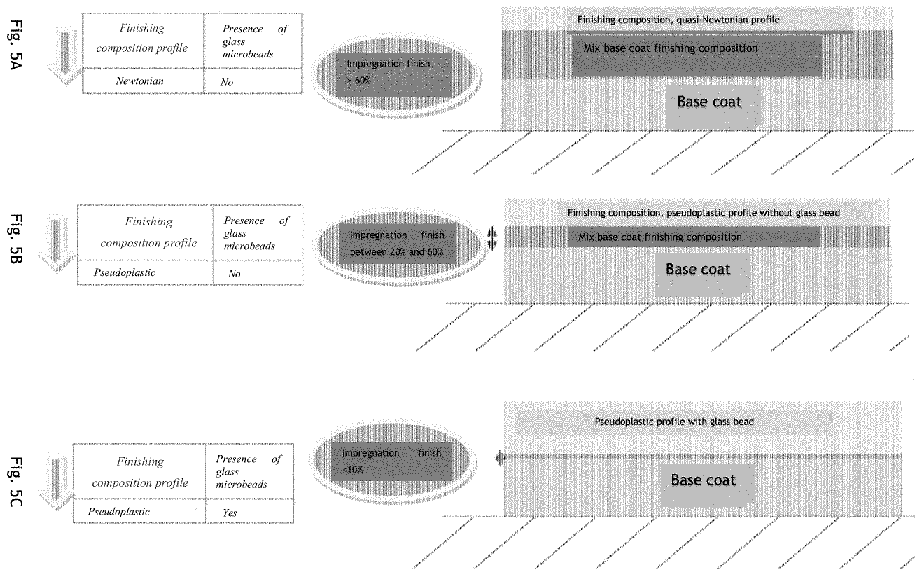

In the context of this study, the evaluation was carried out by exposure to spray for 120 h. FIG. 4A shows the impregnation area of composition A2 after 120 hours of exposure to salt spray. A very little visual degradation in the area is observed. Impregnation was therefore limited with composition A2.

On the other hand, FIG. 4B shows the impregnation area of composition B2 after 72 hours of exposure to salt spray. A strong visual degradation of the area is observed. Impregnation was therefore not limited with composition B2.

In conclusion, to limit this interpenetration (under the treatment conditions of this invention), it is appropriate to use a finishing composition having a thixotropic index greater than or equal to 3 and a pseudo-plastic profile.

### Example 4

### Influence of the Presence of Glass Microbeads

Next, to determine the importance of the glass microbead portion during the transformation method, the impregnation area between the two coats was analyzed by X fluorescence. The following finishing compositions were analyzed:
Quasi-Newtonian profile, thixotropic index less than 2 (ratio calculated between the viscosity at speed 60 and speed 6) and absence of glass microbeads;
Pseudoplastic profile, thixotropic index greater than 4 (ratio calculated between the viscosity at speed 60 and speed 6) and absence of glass microbeads;
Pseudo-plastic profile, thixotropic index greater than 4 and presence of glass microbeads.

These finishing compositions were applied according to the wet-on-wet method of the present invention, that is to say the method comprising the steps described in FIG. 1A. The base coat has a thickness of 10 μm and the finishing composition has a thickness of 4 μm.

FIGS. 5A, 5B and 5C related respectively to each of these finishing compositions summarize the results obtained and allow to demonstrate that:
for a composition having a Newtonian profile, a thixotropic index of less than 2, and not having glass microbeads, the impregnation rate is greater than 60% and may exceed 70 to 80%; and
for the same desired rheological profile, that is to say pseudo-plastic and thixotropic index greater than 4:
   Without glass bead: the impregnation rate of the finishing composition measured by loss of silicon element is evaluated between 20 and 60%; and
   When the glass microbeads (10% PVC) are added to the finishing composition, the impregnation, according to the above method, is less than 10%,

The glass microbeads allow to reinforce the chemical resistance of the system, particularly at a low finishing thickness.

### Example 5

### Influence of the Presence of the Finishing Composition on the System

In the examples which follow, the products were applied on cast iron using the wet-on-wet method (FIG. 1A). The base coat is applied at a thickness of 10-12 μm and the finish coat at a thickness of 6-8 μm. The coated substrates are then subjected to a thermal shock of 450° C. for 24h then exposed to the salt spray for 120 h.

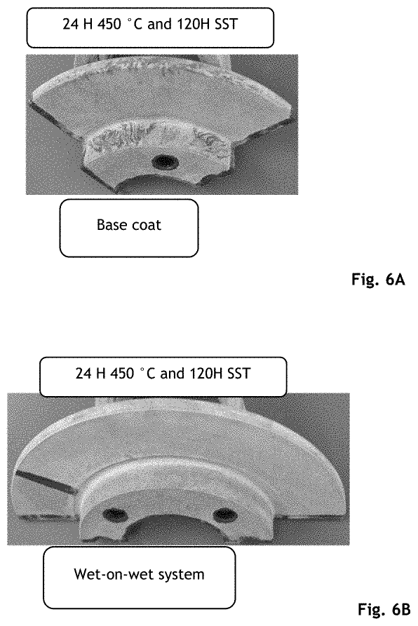

FIG. 6A shows the appearance of the coated substrate comprising a base coat, as described in Table 1, alone. Strong degradation is observed after 48 hours.

FIG. 6B shows the appearance of the substrate coated with a base coat as described in Table 1, and a finish coat as described in Table 2, in a wet-on-wet method subjected to a thermal shock of 450° C. for 24 hours then exposed to salt spray (SST) for 120 h). No degradation is observed.

### Example 6

### Influence of the Temperature of the Substrate Before Application

The wet-on-wet method described in FIG. 1A is implemented by varying the preheating temperature of the substrate and the thickness of the finishing composition. The system obtained is then subjected to a test protocol to establish their performance. This test protocol is based on exposure to various rim cleaners for 10 or 30 minutes, rinsing and exposure for 120 hours to salt spray.

The rim cleaners tested are:
Sineo™ (pH 13)—SADAPS BARDAHL additives and lubricants
Aluminum Teufel (pH<1)—TUGA Chemie Gmbh
Neutral Cleaner (pH 8).

Table 9 below summarizes the different results of resistance to salt spray after exposure to rim cleaners.

TABLE 9

| Substrate | Finish coat thickness | | | | |
|---|---|---|---|---|---|
| temperature | 1 μm | 2 μm | 4 μm | 6 μm | 8 μm |
| 30° C. | Poor | Poor | Poor | Poor | Out of |
| | chemical | chemical | chemical | chemical | measure- |
| | resistance | resistance | resistance | resistance | ment limit |
| 40° C. | Good | Good | Good | Good | Good |
| | chemical | chemical | chemical | chemical | chemical |
| | resistance | resistance | resistance | resistance | resistance |
| 55° C. | Good | Good | Good | Good | Good |
| | chemical | chemical | chemical | chemical | chemical |
| | resistance | resistance | resistance | resistance | resistance |

Optimal corrosion resistance performance after chemical attack and 120 hours of exposure to salt spray is obtained for a substrate preheating at least equal to 40° C.

### Example 7

### Influence of the Time Between the Application of the Base Coat and the Application of the Finish Coat (Configuration 10 μm of Base Coat and 4 μm of Finish Coat on Machined Cast Iron)

The wet-on-wet method described in FIG. 1A is implemented by varying the time between the application of the base coat and the application of the finish coat from 10 to 40 seconds, in increments of 5 seconds. The system obtained is then subjected to a test protocol to establish their performance.

This test protocol is based on an exposure to different rim cleaners for 10 minutes or 30 minutes, rinsing and exposure for 120 h to salt spray.

The rim cleaners tested are:
Sineo™ (pH 13)—SADAPS BARDAHL additives and lubricants
Aluminum Teufel (pH<1)—TUGA Chemie Gmbh
Neutral Cleaner (pH 8).

Table 10 below summarizes the various results obtained.

TABLE 10

| | Time of exposure to salt spray | | |
|---|---|---|---|
| Time | 120 h | 264 h | 456 h |
| 10 seconds | Good chemical | Good chemical | Good chemical |
| | resistance | resistance | resistance |
| 15 seconds | Good chemical | Good chemical | Good chemical |
| | resistance | resistance | resistance |
| 20 seconds | Good chemical | Good chemical | Good chemical |
| | resistance | resistance | resistance |
| 25 seconds | Good chemical | Low chemical | — |
| | resistance | resistance | |
| 30 seconds | Good chemical | Low chemical | — |
| | resistance | resistance | |
| 35 seconds | Good chemical | Low chemical | — |
| | resistance | resistance | |
| 40 seconds | Good chemical | Low chemical | — |
| | resistance | resistance | |
| 50 seconds | Bubbling | — | — |
| | observed on the | | |
| | surface | | |

Conclusion

The time between the application of the base coat and the finish coat is important for two reasons:
It plays a role in the corrosion resistance after chemical exposure according to our test protocol; and
It also plays a role in the final appearance of the film.

1. A finishing composition for coating a metal part previously coated with a corrosion-resistant coating, comprising at least a binder of alkylphenylsiloxane type, glass microbeads, and optionally filler particles with a high thermal resistance and/or particulate aluminum, said composition having a thixotropic index (ITh) greater than or equal to 3.

2. The composition according to claim 1, characterized in that its rheological profile is a pseudo plastic profile.

3. The composition according to claim 1, characterized in that the content of binder of alkylphenylsiloxane type, expressed by its dry matter content, is less than or equal to 30% by mass, preferably comprised between 10% and 30% by mass, more particularly between 15% and 18% by mass, relative to the total mass of the finishing composition.

4. The composition according to claim 1, characterized in that the content of glass microbeads is comprised between 2% and 5% by mass, more particularly between 3.5% and 4.5% by mass, relative to the total mass of the finishing composition.

5. The composition according to claim 1, characterized in that it further comprises a thickening agent and/or a dispersing agent and/or a wetting agent.

6. The composition according to claim 1, characterized in that it comprises aluminum particles, in particular aluminum particles of the lamellar type.

7. The composition according to claim 6, characterized in that the content of aluminum particles, in particular of lamellar-type aluminum particles is greater than or equal to 10% by mass, in particular comprised between 3% and 10% by mass, advantageously between 3% and 5% by mass, relative to the total mass of the finishing composition.

8. A corrosion-resistant coating of a metal part comprising at least two coats different from each other, the first coat being a base coat comprising at least water, a particulate metal and a binder, and the second coat being a finishing composition as defined in claim 1.

9. A method for applying a corrosion-resistant coating as defined in claim 8 on a metal substrate, comprising a step of applying said finishing composition to said base coat previously applied to the metal substrate, characterized in that said base coat is still wet during the application of the finishing composition.

10. The method according to claim 9, characterized in that the step of applying the finishing composition is carried out by spraying.

11. The method according to claim 9, characterized in that it comprises a pause time comprised between 5 seconds and 40 seconds, advantageously between 10 seconds and 20 seconds, between the application of the base coat on the metal substrate and the application of the finishing composition on the base coat.

12. The method according to claim 9, characterized in that it comprises a first step of preheating the metal substrate to a temperature greater than 36° C., preferably comprised between 36° C. and 65° C., in particular between 40° C. and 65° C., more particularly between 40° C. and 55° C.

13. The method according to claim 9, characterized in that it comprises a step of baking the metal substrate coated with the base coat and the finishing composition, carried out preferably at a temperature comprised between 280° C. and 400° C., advantageously between 310° C. and 350° C.

14. The method according to claim 13, characterized in that it comprises a drying step prior to the baking step, in particular by convection, infrared or induction.

15. A corrosion-resistant coating of metal parts, characterized in that it is obtained by the method according to claim 9.

16. A metal coated with a corrosion-resistant coating as defined in claim 8.

17. The metal substrate according to claim 16, characterized in that said coating has a uniform thickness comprised between 2 μm and 35 μm, advantageously between 8 μm and 30 μm, more advantageously between 10 μm and 20 μm.
